(19) United States
(12) Patent Application Publication
(10) Pub. No.: US 2007/0082814 A1
(43) Pub. Date: Apr. 12, 2007

(54) Ternary nanocatalyst and method of making

(75) Inventors: Mark K. Debe, Stillwater, MN (US); Susan M. Hendricks, Cottage Grove, MN (US); George D. Vernstrom, Inver Grove Heights, MN (US); Amy E. Hester, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/248,441

(22) Filed: Oct. 12, 2005

(51) Int. Cl. B01J 23/32

(52) U.S. Cl. 502/324

(57) ABSTRACT

A method is provided for making a supported catalyst comprising nanostructured elements which comprise microstructured support whiskers bearing nanoscopic catalyst particles, where the method comprises the step of depositing a catalyst material comprising at least three metallic elements on microstructured support whiskers from a single target comprising at least three metallic elements. Typically, at least one of said metallic elements is Pt. In addition, one or more of said metallic elements may be Mn, Ni or Co. Other metallic elements or other transition metal elements may be included. In addition, the present invention provides a supported catalyst comprising nanostructured elements which comprise microstructured support whiskers bearing nanoscopic catalyst particles made according to the method of the present invention. Further, the present invention provides fuel cell membrane electrode assembly comprising the supported catalyst according to the present invention.

This invention was made with Government support under Cooperative Agreement DE-FC36-02AL67621 awarded by DOE. The Government has certain rights in this invention.

### FIELD OF THE INVENTION

This invention relates to nanostructured thin film (NSTF) catalysts including three or more metallic elements. The catalysts according to the present invention may be useful as fuel cell catalysts.

### BACKGROUND OF THE INVENTION

U.S. Pat. No. 5,879,827, the disclosure of which is incorporated herein by reference, discloses nanostructured elements comprising acicular microstructured support whiskers bearing acicular nanoscopic catalyst particles. The catalyst particles may comprise alternating layers of different catalyst materials which may differ in composition, in degree of alloying or in degree of crystallinity.

U.S. Pat. App. Pub. No. 2002/0004453 A1, the disclosure of which is incorporated herein by reference, discloses fuel cell electrode catalysts comprising alternating platinum-containing layers and layers containing suboxides of a second metal that display an early onset of CO oxidation.

U.S. Pat. Nos. 5,338,430, 5,879,828, 6,040,077 and 6,319,293, the disclosures of which are incorporated herein by reference, also concern nanostructured thin film catalysts.

U.S. Pat. Nos. 4,812,352, 5,039,561, 5,176,786, and 5,336,558, the disclosures of which are incorporated herein by reference, concern microstructures.

U.S. patent application Ser. No. 10/674,594, the disclosure of which is incorporated herein by reference, discloses fuel cell cathode catalysts comprising nanostructures formed by depositing alternating layers of platinum and a second layer onto a microstructure support, which may form a ternary catalyst.

U.S. Pat. No. 5,079,107 discloses a catalyst for a phosphoric acid electrolyte fuel cell comprising a ternary alloy of Pt—Ni—Co, Pt—Cr—C or Pt—Cr—Ce.

U.S. Pat. No. 4,985,386 discloses a catalyst on a carbon support, the catalyst comprising carbides of Pt, carbides of a second metal selected from Ni, Co, Cr and Fe, and optionally carbides of Mn. The reference also discloses a method of making a carbon supported catalyst by reductive deposition of metal ions onto carbon supports followed by alloying and at least partial carburizing of the metals by application of heat and carbon-containing gasses.

U.S. Pat. No. 5,593,934 discloses a catalyst on a carbon support, the catalyst comprising 40-90 atomic % Pt, 30-5 atomic % Mn and 30-5 atomic % Fe. The reference includes comparative examples purportedly demonstrating carbon-supported catalysts comprising 50 atomic % Pt, 25 atomic % Ni and 25 atomic % Co; 50 atomic % Pt and 50 atomic % Mn; and Pt alone.

U.S. Pat. No. 5,872,074 discloses a catalyst made by first preparing a metastable composite or alloy which comprises crystallites having a grain size of 100 nm or lower and then leaching away one of the elements of that alloy.

Markovic et al., Oxygen Reduction Reaction on Pt and Pt Bimetallic Surfaces: A Selective Review, Fuel Cells, 2001, Vol. 1, No. 2 (pp. 105-116) examines reactions at crystal surfaces of bimetallic Pt—Ni and Pt—Co catalysts made by underpotential deposition method, the classical metallurgical method and deposition of pseudomorphic metal films.

Paulus et al., Oxygen Reduction on Carbon-Supported Pt—Ni and Pt—Co Alloy Catalysts, J. Phys. Chem. B, 2002, No. 106 (pp. 4181-4191) examines commercially available carbon-supported catalysts comprising Pt—Ni and Pt—Co alloys.

### SUMMARY OF THE INVENTION

Briefly, the present invention provides a method of making a supported catalyst comprising nanostructured elements which comprise microstructured support whiskers bearing nanoscopic catalyst particles, where the method comprises the step of depositing a catalyst material comprising at least three metallic elements on microstructured support whiskers from a single target comprising at least three metallic elements. Typically, at least one of said metallic elements is Pt. In addition, one or more of said metallic elements may be Mn, Ni or Co. Other metallic elements may be included. Other transition metal elements may be included.

In addition, the present invention provides a supported catalyst comprising nanostructured elements which comprise microstructured support whiskers bearing nanoscopic catalyst particles made according to the method of the present invention. Further, the present invention provides fuel cell membrane electrode assembly comprising the supported catalyst according to the present invention.

In this application:

“membrane electrode assembly” means a structure comprising a membrane that includes an electrolyte, typically a polymer electrolyte, and at least one but more typically two or more electrodes adjoining the membrane;

“nanostructured element” means an acicular, discrete, microscopic structure comprising a catalytic material on at least a portion of its surface;

“nanoscopic catalyst particle” means a particle of catalyst material having at least one dimension equal to or smaller than about 15 nm or having a crystallite size of about 15 nm or less, as measured from diffraction peak half widths of standard 2-theta x-ray diffraction scans;

“acicular” means having a ratio of length to average cross-sectional width of greater than or equal to 3;

“discrete” refers to distinct elements, having a separate identity, but does not preclude elements from being in contact with one another;

“microscopic” means having at least one dimension equal to or smaller than about a micrometer;

“planar equivalent thickness” means, in regard to a layer distributed on a surface, which may be distributed unevenly, and which surface may be an uneven surface (such as a layer of snow distributed across a landscape, or a layer of atoms distributed in a process of vacuum deposition), a thickness calculated on the assumption that the total mass of the layer was spread evenly over a plane covering the same projected area as the surface (noting that the projected area covered by the surface is less than or equal to the total surface area of the surface, once uneven features and convolutions are ignored);

“bilayer planar equivalent thickness” means the total planar equivalent thickness of a first layer (as described herein) and the next occurring second layer (as described herein); and

the symbol “Å” represents Angstroms, notwithstanding any typographical or computer error.

It is an advantage of the present invention to provide cathode catalysts for use in fuel cells.

### DETAILED DESCRIPTION

The present invention provides a method of making a supported catalyst comprising nanostructured elements which comprise microstructured support whiskers bearing nanoscopic catalyst particles, where the method comprises the step of depositing a catalyst material comprising at least three metallic elements on microstructured support whiskers from a single target comprising at least three metallic elements. Typically, at least one of said metallic elements is Pt. In addition, one or more of said metallic elements may be Mn, Ni or Co. Other metallic elements may be included. Other transition metal elements may be included. The metallic elements may be included in any suitable ratios. In addition, the present invention provides a supported catalyst comprising nanostructured elements which comprise microstructured support whiskers bearing nanoscopic catalyst particles made according to the method of the present invention.

The present invention provides a method of making a catalyst which comprises nanostructured elements comprising microstructured support whiskers bearing nanoscopic catalyst particles. U.S. Pat. Nos. 4,812,352, 5,039,561, 5,176,786, and 5,336,558, the disclosures of which are incorporated herein by reference, concern microstructures which may be used in the practice of the present invention. U.S. Pat. Nos. 5,338,430, 5,879,827, 6,040,077 and 6,319,293 and U.S. Pat. App. Pub. No. 2002/0004453 A1, the disclosures of which are incorporated herein by reference, describe nanostructured elements comprising microstructured support whiskers bearing nanoscopic catalyst particles. U.S. Pat. No. 5,879,827 and U.S. Pat. App. Pub. No. 2002/0004453 A1, the disclosures of which are incorporated herein by reference, describe nanoscopic catalyst particles comprising alternating layers.

The catalyst material useful in the present invention comprises at least three metallic elements. The metallic elements may be included in any suitable ratios. Typically, the metallic elements are chosen from transition metals, most typically those selected from the group consisting of Group VIb metals, Group VIIb metals and Group VIIIb metals. Typically at least one of said metallic elements is Pt. Typically, Pt comprises between 1% and 99% of the catalyst material, more typically between 10% and 90%. In addition, one or more of said metallic elements may be Mn, Ni or Co. Other metallic elements may be included. Additional metallic elements are added to impart improved functionality, which may include improved activity, improved durability and the like, particularly under conditions of high potential and/or high temperature which may exist during use of the catalyst, which may be in operation of a fuel cell.

In one embodiment wherein the catalyst includes Pt, the volume ratio of Pt to the sum of all other metals in the catalyst is between about 2 and about 4, more typically between 2 and 4, more typically between about 2.5 and about 3.5, more typically between 2.5 and 3.5, and most typically about 3. In one embodiment wherein the catalyst includes Mn, the Mn content is equal to or greater than about 5 micrograms/cm² areal density. In one embodiment wherein the catalyst includes Pt and Mn, the volume ratio of platinum to manganese to the remainder of the other metals is about 6:1:1.

Typically, the method according to the present invention comprises vacuum deposition. Typically the vacuum deposition steps are carried out in the absence of oxygen or substantially in the absence of oxygen. Typically, sputter deposition is used. Any suitable microstructures may be used, including organic or inorganic microstructures. Typical microstructures are described in U.S. Pat. Nos. 4,812,352, 5,039,561, 5,176,786, 5,336,558, 5,338,430, 5,879,827, 6,040,077 and 6,319,293, and U.S. Pat. App. Pub. No. 2002/0004453 A1, the disclosures of which are incorporated herein by reference. Typical microstructures are made by thermal sublimation and vacuum annealing of the organic pigment C.I. Pigment Red 149, i.e., N,N′-di(3,5-xylyl)perylene-3,4:9,10-bis(dicarboximide). Methods for making organic nanostructured layers are disclosed in Materials Science and Engineering, A158 (1992), pp. 1-6; J. Vac. Sci. Technol. A, 5 (4), July/August, 1987, pp. 1914-16; J. Vac. Sci. Technol. A, 6, (3), May/August, 1988, pp. 1907-11; Thin Solid Films, 186, 1990, pp. 327-47; J. Mat. Sci., 25, 1990, pp. 5257-68; Rapidly Quenched Metals, Proc. of the Fifth Int. Conf. on Rapidly Quenched Metals, Wurzburg, Germany (Sep. 3-7, 1984), S. Steeb et al., eds., Elsevier Science Publishers B.V., New York, (1985), pp. 1117-24; Photo. Sci. and Eng., 24, (4), July/August, 1980, pp. 211-16; and U.S. Pat. Nos. 4,568,598, 4,340,276, the disclosures of the patents are incorporated herein by reference. Properties of catalyst layers using carbon nanotube arrays are disclosed in the article “High Dispersion and Electrocatalytic Properties of Platinum on Well-Aligned Carbon Nanotube Arrays,” Carbon 42 (2004) 191-197. Properties of catalyst layers using grassy or bristled silicon are disclosed in U.S. Pat. App. Pub. 2004/0048466 A1.

Vacuum deposition may be carried out in any suitable apparatus, such as described in U.S. Pats. Nos. 5,338,430, 5,879,827, 5,879,828, 6,040,077 and 6,319,293 and U.S. Pat. App. Pub. No. 2002/0004453 A1, the disclosures of which are incorporated herein by reference. One such apparatus is depicted schematically in FIG. 4A of U.S. Pat. No. 5,338,430, and discussed in the accompanying text, wherein the substrate is mounted on a drum which is then rotated under a DC magnetron sputtering source.

It will be understood by one skilled in the art that the crystalline and morphological structure of a catalyst such as that according to the present invention, including the presence, absence, or size of alloys, amorphous zones, crystalline zones of one or a variety of structural types, and the like, may be highly dependent upon process and manufacturing conditions, particularly when three or more elements are combined.

Further, the present invention provides fuel cell membrane electrode assembly comprising the supported catalyst according to the present invention. The catalysts of the present invention can be used to manufacture catalyst coated membranes (CCM's) or membrane electrode assemblies (MEA's) incorporated in fuel cells such as are described in U.S. Pat. Nos. 5,879,827 and 5,879,828, the teachings of which are incorporated herein by reference.

The membrane electrode assembly (MEA) according to the present invention may be used in fuel cells. An MEA is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts, typically including platinum metal. The PEM forms a durable, non-porous, electrically non-conductive mechanical barrier between the reactant gases, yet it also passes H⁺ ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's and the resulting catalyst-coated GDL's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA.

A PEM used in a CCM or MEA according to the present invention may comprise any suitable polymer electrolyte. The polymer electrolytes useful in the present invention typically bear anionic functional groups bound to a common backbone, which are typically sulfonic acid groups but may also include carboxylic acid groups, imide groups, amide groups, or other acidic functional groups. The polymer electrolytes useful in the present invention are typically highly fluorinated and most typically perfluorinated. The polymer electrolytes useful in the present invention are typically copolymers of tetrafluoroethylene and one or more fluorinated, acid-functional comonomers. Typical polymer electrolytes include Nafion®(DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent application Ser. Nos. 10/322,254, 10/322,226 and 10/325,278, which are incorporated herein by reference. The polymer typically has an equivalent weight (EW) of 1200 or less, more typically 1100 or less, more typically 1000 or less, and may have an equivalent weight of 900 or less, or 800 or less.

The polymer can be formed into a membrane by any suitable method. The polymer is typically cast from a suspension. Any suitable casting method may be used, including bar coating, spray coating, slit coating, brush coating, and the like. Alternately, the membrane may be formed from neat polymer in a melt process such as extrusion. After forming, the membrane may be annealed, typically at a temperature of 120° C. or higher, more typically 130° C. or higher, most typically 150° C. or higher. The PEM typically has a thickness of less than 50 microns, more typically less than 40 microns, more typically less than 30 microns, and in some embodiments about 25 microns.

In one embodiment of the present invention, one or more manganese oxides, such as MnO₂ or Mn₂O₃, is added to the polymer electrolyte prior to membrane formation. Typically the oxide is mixed well with the polymer electrolyte to achieve substantially uniform distribution. Mixing is achieved by any suitable method, including milling, kneading and the like, and may occur with or without the inclusion of a solvent. The amount of oxide added is typically between 0.01 and 5 weight percent based on the total weight of the final polymer electrolyte or PEM, more typically between 0.1 and 2 wt %, and more typically between 0.2 and 0.3 wt %. Factors mitigating against inclusion of excessive manganese oxide include reduction of proton conductivity, which may become a significant factor at greater than 0.25 wt % oxide.

In one embodiment of the present invention, a salt of manganese is added to the acid form polymer electrolyte prior to membrane formation. Typically the salt is mixed well with or dissolved within the polymer electrolyte to achieve substantially uniform distribution. The salt may comprise any suitable anion, including chloride, bromide, nitrate, carbonate and the like. Once cation exchange occurs between the transition metal salt and the acid form polymer, it may be desirable for the acid formed by combination of the liberated proton and the original salt anion to be removed. Thus, it may be preferred to use anions that generate volatile or soluble acids, for example chloride or nitrate. Manganese cations may be in any suitable oxidation state, including Mn²⁺, Mn³⁺ and Mn⁴⁺, but are most typically Mn²⁺. Without wishing to be bound by theory, it is believed that the manganese cations persist in the polymer electrolyte because they are exchanged with H⁺ ions from the anion groups of the polymer electrolyte and become associated with those anion groups. Furthermore, it is believed that polyvalent manganese cations may form crosslinks between anion groups of the polymer electrolyte, further adding to the stability of the polymer. The amount of salt added is typically between 0.001 and 0.5 charge equivalents based on the molar amount of acid functional groups present in the polymer electrolyte, more typically between 0.005 and 0.2, more typically between 0.01 and 0.1, and more typically between 0.02 and 0.05.

In making an MEA, GDL's may be applied to either side of a CCM. The GDL's may be applied by any suitable means. Any suitable GDL may be used in the practice of the present invention. Typically the GDL is comprised of sheet material comprising carbon fibers. Typically the GDL is a carbon fiber construction selected from woven and non-woven carbon fiber constructions. Carbon fiber constructions which may be useful in the practice of the present invention may include: Toray™ Carbon Paper, SpectraCarb™ Carbon Paper, AFN™ non-woven carbon cloth, Zoltek™ Carbon Cloth, and the like. The GDL may be coated or impregnated with various materials, including carbon particle coatings, hydrophilizing treatments, and hydrophobizing treatments such as coating with polytetrafluoroethylene (PTFE).

In use, the MEA according to the present invention is typically sandwiched between two rigid plates, known as distribution plates, also known as bipolar plates (BPP's) or monopolar plates. Like the GDL, the distribution plate must be electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates.

This invention is useful in the manufacture and operation of fuel cells.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all reagents were obtained or are available from Aldrich Chemical Co., Milwaukee, Wis., or may be synthesized by known methods.

In this example, a nanostructured thin film PtCoMn ternary catalyst according to the present invention was made by a method including deposition of the multi-element catalyst composition from a single sputtering target.

PR149 Microstructures

Nanostructured Support Films employed as catalyst supports were made according to the process described in U.S. Pat. Nos. 5,338,430, 4,812,352 and 5,039,561, incorporated herein by reference, using as substrates the microstructured catalyst transfer substrates (or MCTS) described in U.S. Pat. No. 6,136,412, also incorporated herein by reference. Nanostructured perylene red (PR149, American Hoechst Corp., Somerset, N.J.) films on microstructured substrates were made by thermal sublimation and vacuum annealing of the organic pigment C.I. Pigment Red 149, i.e., N,N′-di(3,5-xylyl)perylene-3,4:9,10-bis(dicarboximide). After deposition and annealing, highly oriented crystal structures were formed with large aspect ratios, average lengths of about 0.75 micrometers, widths of about 0.03-0.05 micrometer and areal number density of approximately 55 whiskers per square micrometer, oriented substantially normal to the underlying substrate.

Nanostructured Catalysts

Catalyst material was deposited on PR149 microstructures by sputter deposition. Catalyst material was deposited from a single target, a 2 in.×10 in. (5 cm×25 cm) planar magnetron ternary PtCoMn target fabricated by Williams Advanced Materials. The composition of the target was, by atomic ratio: 49.86% Pt, 45.13% Co, and 5.01% Mn, or approximately 10:9:1.

The apparatus used was that described in U.S. patent application Ser. No. 10/674,594, except that a single ternary target was used. This deposition system was equipped with a 24 inch (61 cm) drum and web control system. The main chamber was equipped with 3 cryopumps (two 6 inch (15 cm) pumps and one 16 inch (41 cm) pump, from CTI Cryogenics) capable of reducing pressure to below 7×10−5 Pa after an overnight pump-down. Such low pressures aid in production of catalytic materials having low oxide content. The main chamber was fitted with the 2×10 inch (5×25 cm) planar DC magnetron capable of producing a uniform deposition region over a 6 inch (15 cm) wide web. The substrates were attached to the rotating drum and passed under the target at 2 ft/min a total of two times. The magnetrons were operated in 5.4 m Torr of Argon and a background pressure of 2 E-6 Torr. The magnetrons were powered by MDX-10K AE power supplies at 800 Watts of power.

The Pt loading of the deposited ternary applied to the nanostructured thin film catalyst layer was 0.08 mg/cm².

Catalyst-Coated Membrane and Membrane Electrode Assembly

A catalyst coated membrane (CCM) was made by lamination transfer of a pure Pt NSTF anode catalyst (0.15 mg/cm²), and the ternary catalyst cathode described above, to a 1.36 micron thick cast PEM with equivalent weight of about 1000. The diffusion-current collectors (DCC) placed on either side of the CCM to form the MEA were fabricated by coating a gas diffusion micro-layer on one side of a Textron carbon cloth electrode backing layer that had been treated with Teflon to improve hydrophobicity.

The MEA's were installed in 50 cm² cells, having quad-serpentine flow fields, at about 30% compression, and operated under a scripted protocol until the performance stabilized. Testing continued under multiple sets of operating conditions, including potentiodynamic scanning (PDS) at ambient pressure with constant flow conditions, and galvanodynamic scanning (GDS) at 30 psig (3 atmospheres absolute=about 303 kPa), with constant stoichiometric flow rates. The specific activity was measured as described in Debe et al., “Activities of Low Pt Loading, Carbon-less, Ultra-Thin Nanostructured Film-Based Electrodes for PEM Fuel Cells and Roll-Good Fabricated MEA Performances in Single Cells and Stacks,” 2003 Fuel Cell Seminar Abstract Book, pp. 812-815 (“2003 FC Abstract,” incorporated herein by reference) at p. 813, including FIGS. 2 and 3 and references described therein. In this method, the current produced by the MEA is measured from the MEA under H₂/O₂ at a total pressure of 150 kPa of saturated oxygen (100% RH), 15 minutes after setting the cell potential at 900 mV. The current densities are then corrected for cell shorting, hydrogen cross-over and IR losses. The specific activity (A/cm² of Pt surface area) was then calculated by dividing the corrected current density at 900 mV by the measured electrochemical surface area (ECSA). The ECSA was measured as described in the above reference as 9 cm² Pt/cm² planar, giving a specific activity of 2.4 mA/cm² Pt surface area. The mass activity (A/mg-Pt) at 900 mV was then calculated by dividing the corrected current density at 900 mV by the mass loading of Pt (0.08 mg/cm²). The result thus obtained was 0.261 A/mg-Pt at 900 mV under 150 kPa absolute of oxygen at 100% relative humidity, which was very high. This value is equivalent to the state-of-the-art PtCo on carbon dispersed alloy catalysts that have 5 to 10 times greater specific surface area (i.e. 50 m²/gram of Pt versus about 10 m²/g-Pt for the nanostructured catalysts of the present invention), as recently documented in H. Gasteiger et al, in Applied Catalysts B:Environmental 56 (2005) 9-35.

Various modifications and alterations of this invention will become apparent to those skilled in the art without departing from the scope and principles of this invention, and it should be understood that this invention is not to be unduly limited to the illustrative embodiments set forth hereinabove.

We claim:

1. A method of making a supported catalyst comprising nanostructured elements which comprise microstructured support whiskers bearing nanoscopic catalyst particles, where the method comprises the step of depositing a catalyst material comprising at least three metallic elements on microstructured support whiskers from a single target comprising at least three metallic elements.

2. The method according to claim 1 wherein at least one of said metallic elements is Pt.

3. The method according to claim 1 wherein at least one of said metallic elements is Mn.

4. The method according to claim 2 wherein at least one of said metallic elements is Mn.

5. The method according to claim 1 wherein at least one of said metallic elements is Co.

6. The method according to claim 2 wherein at least one of said metallic elements is Co.

7. The method according to claim 3 wherein at least one of said metallic elements is Co.

8. The method according to claim 4 wherein at least one of said metallic elements is Co.

9. A supported catalyst comprising nanostructured elements which comprise microstructured support whiskers bearing nanoscopic catalyst particles made according to the method of claim 1.

10. A fuel cell membrane electrode assembly comprising the supported catalyst according to claim 9.

11. A supported catalyst comprising nanostructured elements which comprise microstructured support whiskers bearing nanoscopic catalyst particles made according to the method of claim 2.

12. A fuel cell membrane electrode assembly comprising the supported catalyst according to claim 11.

13. A supported catalyst comprising nanostructured elements which comprise microstructured support whiskers bearing nanoscopic catalyst particles made according to the method of claim 3.

14. A fuel cell membrane electrode assembly comprising the supported catalyst according to claim 13.

15. A supported catalyst comprising nanostructured elements which comprise microstructured support whiskers bearing nanoscopic catalyst particles made according to the method of claim 4.

16. A fuel cell membrane electrode assembly comprising the supported catalyst according to claim 15.

17. A supported catalyst comprising nanostructured elements which comprise microstructured support whiskers bearing nanoscopic catalyst particles made according to the method of claim 6.

18. A fuel cell membrane electrode assembly comprising the supported catalyst according to claim 17.

19. A supported catalyst comprising nanostructured elements which comprise microstructured support whiskers bearing nanoscopic catalyst particles made according to the method of claim 8.

20. A fuel cell membrane electrode assembly comprising the supported catalyst according to claim 19.
